(19) United States
(12) Patent Application Publication
(10) Pub. No.: US 2019/0331838 A1
(43) Pub. Date: Oct. 31, 2019

(54) OPTICAL LAMINATE, IMAGE DISPLAY DEVICE, AND METHOD OF MANUFACTURING OPTICAL LAMINATE

(71) Applicant: NITTO DENKO CORPORATION, Ibaraki-shi, Osaka (JP)

(72) Inventors: Yoshimi Konno, Ibaraki-shi (JP); Hironori Yaginuma, Ibaraki-shi (JP); Akinori Izaki, Ibaraki-shi (JP); Yoshitsugu Kitamura, Ibaraki-shi (JP)

(73) Assignee: NITTO DENKO CORPORATION, Ibaraki-shi, Osaka (JP)

(21) Appl. No.: 16/468,469

(22) PCT Filed: Nov. 29, 2017
(86) PCT No.: PCT/JP2017/042746

§ 371 Date: Jun. 11, 2019

(30) Foreign Application Priority Data
Dec. 16, 2016 (JP) 2016-244225

(51) Int. Cl. G02B 5/30; G02F 1/1335; B32B 7/02

(52) U.S. Cl. CPC G02B 5/305; B32B 7/02; G02F 1/133528; G02B 5/3083

(57) ABSTRACT

There is provided an optical laminate that can improve viewability by suppressing a hue change in accordance with the angle of polarized sunglasses. An optical laminate of the present invention includes: a first retardation layer; a second retardation layer; a polarizer; and a third retardation layer. The first retardation layer, the second retardation layer, the polarizer, and the third retardation layer is laminated from a viewer side in the stated order.

### TECHNICAL FIELD

The present invention relates to an optical laminate, an image display apparatus, and a method of producing an optical laminate.

### BACKGROUND ART

There has been known an image display apparatus using a ¼ wavelength plate as a touch sensor substrate or the protective substrate of a viewer-side polarizing plate for improving viewability when a viewer views the display screen of the image display apparatus while wearing polarized sunglasses (Patent Literature 1). The image display apparatus of Patent Literature 1 includes the ¼ wavelength plate on the viewer side of the viewer-side polarizing plate, and an angle formed by the absorption axis of the viewer-side polarizing plate and the slow axis of the ¼ wavelength plate is set to 45°. Thus, circularly polarized light is output from the display screen, and as a result, the following problem may be eliminated. When the display screen is observed under a state in which the transmission axis of the polarized sunglasses is perpendicular to the transmission axis of the viewer-side polarizing plate, the display screen darkens.

### CITATION LIST

### Patent Literature

[PTL 1] JP 10-10523 A

### SUMMARY OF INVENTION

### Technical Problem

However, the above-mentioned image display apparatus involves a problem in that, when the viewer views the display screen while wearing the polarized sunglasses, a hue change and a transmittance change in accordance with the angle of the polarized sunglasses occur, and hence the viewability reduces.

The present invention has been made to solve the conventional problem, and a primary object of the present invention is to provide an optical laminate that can improve viewability by suppressing a hue change in accordance with the angle of polarized sunglasses, an image display apparatus including the optical laminate, and a method of producing an optical laminate.

### Solution to Problem

An optical laminate according to an embodiment of the present invention includes: a first retardation layer; a second retardation layer; a polarizer; and a third retardation layer. The first retardation layer, the second retardation layer, the polarizer, and the third retardation layer is laminated from a viewer side in the stated order.

In one embodiment of the present invention, in-plane retardations Re1 of the first retardation layer satisfy the following expressions:

Re1(450)/Re1(550)<1.03; and

Re1(650)/Re1(550)>0.97, and

in-plane retardations Re2 of the second retardation layer satisfy the following expressions:

Re2(450)/Re2(550)≥0.03; and

Re2(650)/Re2(550)≤0.97

where Re1(450) and Re2(450) each represent an in-plane retardation measured at 23° C. with light having a wavelength of 450 nm, Re1(550) and Re2(550) each represent an in-plane retardation measured at 23° C. with light having a wavelength of 550 nm, and Re1(650) and Re2(650) each represent an in-plane retardation measured at 23° C. with light having a wavelength of 650 nm.

In one embodiment of the present invention:

the in-plane retardation Re1(550) of the first retardation layer is from 105 nm to 115 nm, the in-plane retardation Re2(550) of the second retardation layer is from 190 nm to 260 nm, an angle θ1 formed by an absorption axis of the polarizer and a slow axis of the first retardation layer is from 19° to 35°, and an angle θ2 formed by the absorption axis of the polarizer and a slow axis of the second retardation layer is from 77° to 85°;

the in-plane retardation Re1(550) of the first retardation layer is from 116 nm to 125 nm, the in-plane retardation Re2 (550) of the second retardation layer is from 200 nm to 260 nm, the angle θ1 formed by the absorption axis of the polarizer and the slow axis of the first retardation layer is from 15° to 35°, and the angle θ2 formed by the absorption axis of the polarizer and the slow axis of the second retardation layer is from 75° to 85°;

the in-plane retardation Re1(550) of the first retardation layer is from 126 nm to 135 nm, the in-plane retardation Re2 (550) of the second retardation layer is from 210 nm to 260 nm, the angle θ1 formed by the absorption axis of the polarizer and the slow axis of the first retardation layer is from 15° to 35°, and the angle θ2 formed by the absorption axis of the polarizer and the slow axis of the second retardation layer is from 75° to 85°; or

the in-plane retardation Re1(550) of the first retardation layer is from 136 nm to 145 nm, the in-plane retardation Re2 (550) of the second retardation layer is from 220 nm to 270 nm, the angle θ1 formed by the absorption axis of the polarizer and the slow axis of the first retardation layer is from 15° to 31°, and the angle θ2 formed by the absorption axis of the polarizer and the slow axis of the second retardation layer is from 75° to 83°.

In one embodiment of the present invention, the first retardation layer includes a stretched body of a polymer film, and the second retardation layer includes an alignment fixed layer of a liquid crystal compound.

In one embodiment of the present invention, in-plane retardations Re1 of the first retardation layer satisfy the following expressions:

Re1(450)/Re1(550)<1.03; and

Re1(650)/Re1(550)>0.97, and

in-plane retardations Re2 of the second retardation layer satisfy the following expressions:

Re2(450)/Re2(550)<1.03; and

Re2(650)/Re2(550)>0.97

where Re1(450) and Re2(450) each represent an in-plane retardation measured at 23° C. with light having a wavelength of 450 nm, Re1(550) and Re2(550) each represent an in-plane retardation measured at 23° C. with light having a wavelength of 550 nm, and Re1(650) and Re2(650) each represent an in-plane retardation measured at 23° C. with light having a wavelength of 650 nm.

In one embodiment of the present invention, a refractive index ellipsoid of the first retardation layer satisfies a relationship of nx=nz>ny, and a refractive index ellipsoid of the second retardation layer satisfies a relationship of nx>ny=nz.

In one embodiment of the present invention, a refractive index ellipsoid of the first retardation layer satisfies a relationship of nx>ny=nz, and a refractive index ellipsoid of the second retardation layer satisfies a relationship of nx=nz>ny.

According to another aspect of the present invention, there is provided an image display apparatus. The image display apparatus includes the optical laminate as described above.

According to still another aspect of the present invention, there is provided a method of producing an optical laminate of an elongate shape in which a first retardation layer, a second retardation layer, a polarizer, and a third retardation layer are laminated in the stated order. The method includes the step of continuously bonding each of a first film of an elongate shape forming the first retardation layer, a second film of an elongate shape forming the second retardation layer, the polarizer of an elongate shape, and a third film of an elongate shape forming the third retardation layer to an adjacent film while conveying the films and the polarizer.

### Advantageous Effects of Invention

According to the present invention, a hue change in accordance with the angle of polarized sunglasses when a viewer views the display screen of the image display apparatus while wearing the polarized sunglasses is suppressed, and as a result, viewability can be improved.

### BRIEF DESCRIPTION OF DRAWINGS

FIG. 1 is a sectional view of an optical laminate according to one embodiment of the present invention.

FIG. 2 is a sectional view of an optical laminate according to another embodiment of the present invention.

FIG. 3 is a graph for showing hues obtained by transmittance spectrum measurement through the optical laminates of Example 1, Comparative Example 1, and Comparative Example 2.

FIG. 4 is a graph for showing transmittance changes obtained by the transmittance spectrum measurement through the optical laminates of Example 1, Comparative Example 1, and Comparative Example 2.

### DESCRIPTION OF EMBODIMENTS

Embodiments of the present invention are described below. However, the present invention is not limited to these embodiments.

### Definitions of Terms and Symbols

The definitions of terms and symbols used herein are as described below.

### (1) Refractive Indices (nx, ny, and nz)

“nx” represents a refractive index in a direction in which an in-plane refractive index is maximum (that is, slow axis direction), “ny” represents a refractive index in a direction perpendicular to the slow axis in the plane (that is, fast axis direction), and “nz” represents a refractive index in a thickness direction.

### (2) In-plane Retardation (Re)

“Re(λ)” refers to an in-plane retardation measured at 23° C. with light having a wavelength of λ nm. For example, “Re (550)” refers to an in-plane retardation measured at 23° C. with light having a wavelength of 550 nm. The Re(λ) is determined from the equation “Re (λ)=(nx−ny)×d” when the thickness of a layer (film) is represented by d (nm).

### (3) Thickness Direction Retardation (Rth)

“Rth (λ)” refers to a thickness direction retardation measured at 23° C. with light having a wavelength of λ nm. For example, “Rth(550)” refers to a thickness direction retardation measured at 23° C. with light having a wavelength of 550 nm. The Rth(λ) is determined from the equation “Rth(λ)=(nx−nz)×d” when the thickness of a layer (film) is represented by d (nm).

### (4) Nz Coefficient

An Nz coefficient is determined from the equation “Nz=Rth/Re”.

A. Overall Configuration of Optical Laminate

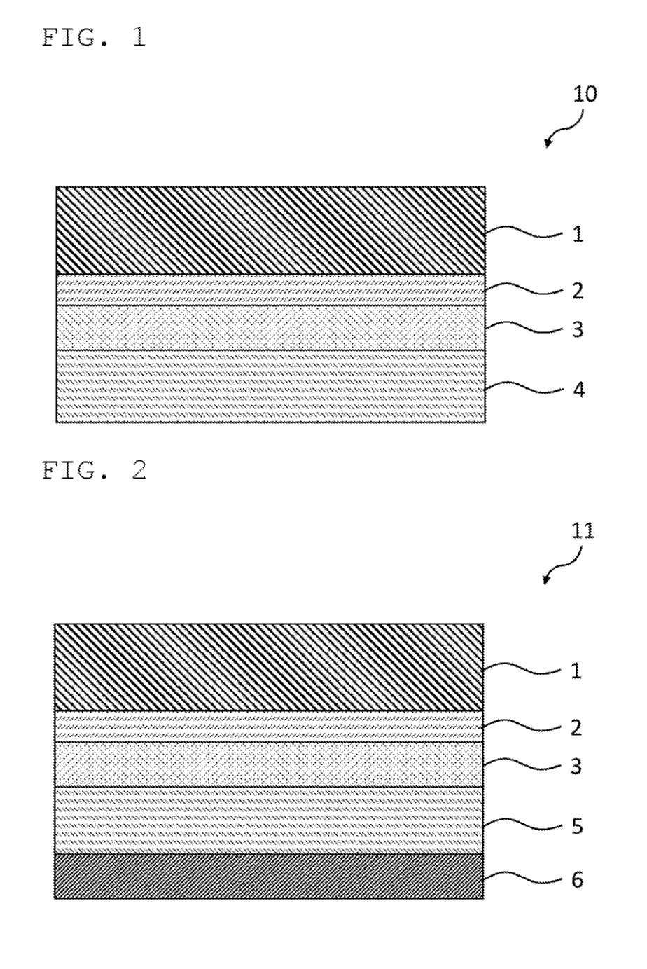

FIG. 1 is a sectional view of an optical laminate according to one embodiment of the present invention. An optical laminate 10 has a configuration in which a first retardation layer 1, a second retardation layer 2, a polarizer 3, and a third retardation layer 4 are laminated in the stated order. The optical laminate 10 is typically used in an image display apparatus (typically a liquid crystal display apparatus or an organic EL display apparatus). The optical laminate 10 is arranged in the image display apparatus so that the first retardation layer 1 may be on its viewer side. That is, under a state in which the optical laminate 10 is arranged in the image display apparatus, the first retardation layer 1, the second retardation layer 2, the polarizer 3, and the third retardation layer 4 are arranged from the viewer side of the image display apparatus in the stated order.

In one embodiment, the first retardation layer 1 shows such a flat wavelength dispersion characteristic that its in-plane retardation value remains substantially unchanged irrespective of the wavelength of measurement light, and the second retardation layer 2 shows such a positive wavelength dispersion characteristic that its in-plane retardation value reduces as the wavelength of the measurement light increases. The in-plane retardations Re1 of the first retardation layer 1 and the in-plane retardations Re2 of the second retardation layer 2 preferably satisfy the following expressions (1) to (4).

Re1(450)/Re1(550)<1.03 (1)

Re1(650)/Re1(550)>0.97 (2)

Re2(450)/Re2(550)≥1.03 (3)

Re2(650)/Re2(550)<0.97 (4)

When the first retardation layer 1 shows a flat wavelength dispersion characteristic, and the second retardation layer 2 shows a positive wavelength dispersion characteristic, the in-plane retardation Re1(550) of the first retardation layer, the in-plane retardation Re2(550) of the second retardation layer, an angle θ1 formed by the absorption axis of the polarizer and the slow axis of the first retardation layer, and an angle θ2 formed by the absorption axis of the polarizer and the slow axis of the second retardation layer preferably satisfy any one of the following (λ) to (D).

(A) Re1(550) is from 105 nm to 115 nm, Re2(550) is from 190 nm to 260 nm, θ1 is from 19° to 35°, and θ2 is from 77° to 85°.
(B) Re1(550) is from 116 nm to 125 nm, Re2(550) is from 200 nm to 260 nm, θ1 is from 15° to 35°, and θ2 is from 75° to 85°.
(C) Re1(550) is from 126 nm to 135 nm, Re2(550) is from 210 nm to 260 nm, θ1 is from 15° to 35°, and θ2 is from 75° to 85°.
(D) Re1(550) is from 136 nm to 145 nm, Re2(550) is from 220 nm to 270 nm, θ1 is from 15° to 31°, and θ2 is from 75° to 83°.

In another embodiment, the first retardation layer 1 shows such a flat wavelength dispersion characteristic that its in-plane retardation value remains substantially unchanged irrespective of the wavelength of measurement light, and the second retardation layer 2 similarly shows such a flat wavelength dispersion characteristic that its in-plane retardation value remains substantially unchanged irrespective of the wavelength of the measurement light. The in-plane retardations Re1 of the first retardation layer 1 and the in-plane retardations Re2 of the second retardation layer 2 preferably satisfy the following expressions (5) to (8).

Re1(450)/Re1(550)<1.03 (5)

Re1(650)/Re1(550)>0.97 (6)

Re2(450)/Re2(550)<1.03 (7)

Re2(650)/Re2(550)>0.97 (8)

Typically, the refractive index ellipsoid of one of the first retardation layer 1 and the second retardation layer 2 satisfies a relationship of nx=nz>ny, and the refractive index ellipsoid of the other satisfies a relationship of nx>ny=nz. That is, one of the first retardation layer 1 and the second retardation layer 2 is a negative A-plate, and the other is a positive A-plate. Typically, the first retardation layer 1 includes a stretched body of a polymer film, and the second retardation layer 2 includes an alignment fixed layer of a liquid crystal compound. The refractive index ellipsoid of the third retardation layer 4 typically satisfies a relationship of nx>nz>ny. When the optical laminate 10 according to the embodiment of the present invention is applied to an image display apparatus so that the first retardation layer 1, the second retardation layer 2, the polarizer 3, and the third retardation layer 4 may be arranged from its viewer side in the stated order, a hue change in accordance with the angle of polarized sunglasses when a viewer views the display screen of the image display apparatus while wearing the polarized sunglasses can be suppressed, and as a result, viewability can be improved.

Practically, the optical laminate 10 may include a surface protective film on the side of the first retardation layer 1 opposite to the second retardation layer 2, and may include a pressure-sensitive adhesive layer on the side of the third retardation layer 4 opposite to the polarizer 3. The optical laminate 10 may practically include a protective layer arranged on at least one side of the polarizer 3. The protective layer is formed of any appropriate film that may be used as a protective layer for a polarizer. A material serving as a main component of the film is specifically, for example: a cellulose-based resin, such as triacetylcellulose (TAC); or a transparent resin, such as a polyester-based, polyvinyl alcohol-based, polycarbonate-based, polyamide-based, polyimide-based, polyether sulfone-based, polysulfone-based, polystyrene-based, polynorbornene-based, polyolefin-based, (meth)acrylic, or acetate-based transparent resin.

FIG. 2 is a sectional view of an optical laminate according to another embodiment of the present invention. An optical laminate 11 has a configuration in which the first retardation layer 1, the second retardation layer 2, the polarizer 3, a third retardation layer 5, and a fourth retardation layer 6 are laminated in the stated order. In this embodiment, typically, the refractive index ellipsoid of the third retardation layer 5 satisfies a relationship of nx>ny>nz, and the refractive index ellipsoid of the fourth retardation layer 6 satisfies a relationship of nz>nx>ny.

The optical laminate may be of a sheet shape, or may be of an elongate shape.

B. First Retardation Layer

It is preferred that the first retardation layer show such a flat wavelength dispersion characteristic that its in-plane retardation value remains substantially unchanged irrespective of the wavelength of measurement light, and the ratio “Re1(450)/Re1(550)” be less than 1.03, and the ratio “Re1(650)/Re1(550)” be more than 0.97. The ratio “Re1(450)/Re1(550)” is more preferably from 0.98 to 1.02, and the ratio “Re1(650)/Re1(550)” is more preferably from 0.98 to 1.02.

The thickness of the first retardation layer may be set so that a desired in-plane retardation may be obtained. Specifically, the thickness is preferably from 1 μm to 80 μm, more preferably from 10 μm to 60 μm, most preferably from 30 μm to 50 μm.

The first retardation layer contains a resin having an absolute value of its photoelastic coefficient of preferably 2×10⁻¹¹ m²/N or less, more preferably from 2.0×10⁻¹³ m²/N to 1.5×10⁻¹¹ m²/N, still more preferably from 1.0×10⁻¹² m²/N to 1.2×10⁻¹¹ m²/N. When the absolute value of the photoelastic coefficient falls within such range, a retardation change is less liable to be generated in the case where a shrinkage stress is generated at the time of heating.

In one embodiment, the refractive index ellipsoid of the first retardation layer satisfies a relationship of nx>ny=nz, and the Nz coefficient of the first retardation layer is, for example, more than 0.9 and less than 1.1. In another embodiment, the refractive index ellipsoid of the first retardation layer satisfies a relationship of nx=nz>ny, and the Nz coefficient of the first retardation layer is, for example, more than −0.1 and less than 0.1.

B-1. First Retardation Layer Whose Refractive Index Ellipsoid Satisfies Relationship of Nx>Ny=Nz

The first retardation layer whose refractive index ellipsoid satisfies a relationship of nx>ny=nz may include any appropriate material that may satisfy such optical characteristics and mechanical characteristics as described above. In one embodiment, the first retardation layer may include any appropriate resin film. A typical example of such resin is a cyclic olefin-based resin.

The cyclic olefin-based resin is a generic term for resins each polymerized by using a cyclic olefin as a polymerization unit, and examples thereof include resins described in JP 01-240517 A, JP 03-14882 A, JP 03-122137 A, and the like. Specific examples thereof include: a ring-opened (co)polymer of the cyclic olefin, an addition polymer of the cyclic olefin, a copolymer (typically a random copolymer) of the cyclic olefin and an α-olefin, such as ethylene or propylene, and graft-modified products obtained by modifying the polymers with unsaturated carboxylic acids or derivatives thereof; and hydrogenated products thereof. Specific examples of the cyclic olefin include norbornene-based monomers. Examples of the norbornene-based monomers include monomers described in JP 2015-210459 A and the like.

In the present invention, any other cycloolefin that may be subjected to ring-opening polymerization may be used in combination to the extent that the object of the present invention is not impaired. Specific examples of such cycloolefin include compounds each having one reactive double bond, such as cyclopentene, cyclooctene, and 5,6-dihydrodicyclopentadiene.

The number-average molecular weight (Mn) of the cyclic olefin-based resin measured by a gel permeation chromatography (GPC) method based on a toluene solvent is preferably from 25,000 to 200,000, more preferably from 30,000 to 100,000, most preferably from 40,000 to 80,000. When the number-average molecular weight falls within the range, a film that is excellent in mechanical strength and has satisfactory solubility, satisfactory formability, and satisfactory casting operability can be obtained.

The cyclic olefin-based resin is commercially available as various products. Specific examples thereof include: products available under the product names “ZEONEX” and “ZEONOR” from Zeon Corporation; a product available under the product name “Arton” from JSR Corporation; a product available under the product name “TOPAS” from TICONA; and a product available under the product name “APEL” from Mitsui Chemicals, Inc.

The first retardation layer is obtained by, for example, stretching a film formed from the cyclic olefin-based resin. Any appropriate forming method may be adopted as a method of forming a film from the cyclic olefin-based resin. For the cyclic olefin-based resin, many film products are commercially available, and hence the commercially available films may each be subjected to stretching treatment as it is.

The film forming the first retardation layer may be of a sheet shape, or may be of an elongate shape. In one embodiment, the first retardation layer is produced by cutting out the resin film, which has been stretched in its elongate direction, in a direction at a predetermined angle with respect to the elongate direction. In another embodiment, the first retardation layer is produced by continuously subjecting the resin film of an elongate shape to oblique stretching in the direction at the predetermined angle with respect to its elongate direction. In still another embodiment, the first retardation layer is produced by: obliquely stretching a laminate of a supporting substrate and a resin layer laminated on the supporting substrate; and transferring the obliquely stretched resin layer (resin film) onto any other layer. When the oblique stretching is adopted, a stretched film of an elongate shape having an alignment angle that is the predetermined angle with respect to the elongate direction of the film (having a slow axis in the direction at the angle) is obtained, and for example, roll-to-roll operation can be performed in its lamination with the other layer. Accordingly, a production process for the optical laminate can be simplified. The predetermined angle may be the angle formed by the absorption axis (elongate direction) of the polarizer and the slow axis of the first retardation layer.

As a stretching machine to be used for the oblique stretching, for example, there is given a tenter stretching machine capable of applying feeding forces, or tensile forces or take-up forces, having different speeds on left and right sides in a lateral direction and/or a longitudinal direction. Examples of the tenter stretching machine include a lateral uniaxial stretching machine and a simultaneous biaxial stretching machine, and any appropriate stretching machine may be used as long as the resin film of an elongate shape can be continuously subjected to the oblique stretching.

Through appropriate control of each of the speeds on the left and right sides in the stretching machine, a first retardation layer having the desired in-plane retardation and having a slow axis in the desired direction can be obtained.

The stretching temperature of the film may be changed depending on, for example, the desired in-plane retardation value and thickness of the first retardation layer, the kind of the resin to be used, the thickness of the film to be used, and a stretching ratio. Specifically, the stretching temperature is preferably from Tg−30° C. to Tg+30° C., more preferably from Tg−15° C. to Tg+15° C., most preferably from Tg−10° C. to Tg+10° C. When the stretching is performed at such temperature, a first retardation layer having an in-plane retardation that allows the effect of the present invention to be appropriately exhibited can be obtained. Tg refers to the glass transition temperature of a constituent material for the film.

B-2. First Retardation Layer Whose Refractive Index Ellipsoid Satisfies Relationship of Nx=Nz>Ny

The first retardation layer whose refractive index ellipsoid satisfies a relationship of nx=nz>ny may include any appropriate material that may satisfy such optical characteristics and mechanical characteristics as described above. In one embodiment, the first retardation layer may include any appropriate resin film containing, as a main component, a thermoplastic resin having a negative intrinsic birefringence value. A polymer having negative intrinsic birefringence is preferably used as a material forming an optical element having negative refractive index anisotropy. The polymer having negative intrinsic birefringence refers to such a polymer that, when the polymer is aligned by stretching or the like, its refractive index in the alignment direction becomes relatively small. The polymer having negative intrinsic birefringence is, for example, a polymer having a chemical bond or functional group having large polarization anisotropy, such as an aromatic group or a carbonyl group, introduced into a side chain thereof, and specific examples thereof include an acrylic resin, a styrene-based resin, a maleimide-based resin, and a fumaric acid ester-based resin. The description “ny=nz” in a positive A-plate or the description “nz=nx” in a negative A-plate is not necessarily required to mean that an in-plane refractive index (nx or ny) and a refractive index nz in a thickness direction completely coincide with each other. When the Nz coefficient of a retardation layer represented by Nz=(nx−nz)/(nx−ny) falls within the range of from 0.97 to 1.03, the retardation layer may be regarded as a positive A-plate satisfying a relationship of ny=nz, and when the Nz coefficient falls within the range of from −0.03 to 0.03, the retardation layer may be regarded as a negative A-plate satisfying a relationship of nx=nz.

The first retardation layer is obtained by, for example, stretching the resin film containing, as a main component, the thermoplastic resin having a negative intrinsic birefringence value. Any appropriate stretching method may be adopted as a method of stretching the resin film containing, as a main component, the thermoplastic resin having a negative intrinsic birefringence value. A preferred method involves: bonding a shrinkable film to each of both surfaces of the resin film containing, as a main component, the thermoplastic resin; and stretching the resultant under heat with a roll stretching machine according to a longitudinal uniaxial stretching method. The shrinkable film is used for applying a shrinkage force in a direction perpendicular to the stretching direction at the time of the heat stretching to increase the refractive index of the resin film in its thickness direction (nz). Although a method of bonding the shrinkable film to each of both surfaces of the resin film is not particularly limited, a method involving arranging an acrylic pressure-sensitive adhesive layer containing an acrylic polymer as a base polymer between the resin film and the shrinkable film to bond the films is preferred because of its excellent workability and excellent economical efficiency. Details about a method of forming the resin film forming the first retardation layer of this embodiment are described in JP 2007-193365 A. The description of the laid-open publication is incorporated herein by reference. In one embodiment, the first retardation layer is produced by continuously subjecting the resin film of an elongate shape to oblique stretching in a direction at a predetermined angle with respect to its elongate direction. In this case, the retardation layer is preferably produced by: laminating the resin film having bonded thereto the shrinkable films on a supporting substrate; obliquely stretching the laminate; and transferring the obliquely stretched resin film onto any other layer.

C. Second Retardation Layer

In one embodiment, the second retardation layer shows such a positive wavelength dispersion characteristic that its in-plane retardation value reduces as the wavelength of measurement light increases, and the ratio “Re2(450)/Re2(550)” is 1.03 or more, and the ratio “Re2(650)/Re2(550)” is 0.97 or less. The ratio “Re2(450)/Re2(550)” is more preferably from 1.03 to 1.15, and the ratio “Re2(650)/Re2(550)” is more preferably from 0.90 to 0.97. In another embodiment, the second retardation layer shows such a flat wavelength dispersion characteristic that the in-plane retardation value remains substantially unchanged irrespective of the wavelength of the measurement light, and the ratio “Re2(450)/Re2(550)” is less than 1.03, and the ratio “Re2(650)/Re2(550)” is more than 0.97. The ratio “Re2(450)/Re2(550)” is more preferably from 0.98 to 1.02, and the ratio “Re2(650)/Re2(550)” is more preferably from 0.98 to 1.02.

C-1. Second Retardation Layer Showing Positive Wavelength Dispersion Characteristic

When the first retardation layer shows a flat wavelength dispersion characteristic, and the second retardation layer shows a positive wavelength dispersion characteristic, as described above, Re1(550), Re2(550), 81, and 82 preferably satisfy any one of the following (λ) to (D).

(A) Re1(550) is from 105 nm to 115 nm, Re2(550) is from 190 nm to 260 nm, θ1 is from 19° to 35°, and θ2 is from 77° to 85°.
(B) Re1(550) is from 116 nm to 125 nm, Re2(550) is from 200 nm to 260 nm, θ1 is from 15° to 35°, and θ2 is from 75° to 85°.
(C) Re1(550) is from 126 nm to 135 nm, Re2(550) is from 210 nm to 260 nm, θ1 is from 15° to 35°, and θ2 is from 75° to 85°.
(D) Re1(550) is from 136 nm to 145 nm, Re2(550) is from 220 nm to 270 nm, θ1 is from 15° to 31°, and θ2 is from 75° to 83°.

When the first retardation layer 1 shows a flat wavelength dispersion characteristic, and the second retardation layer 2 shows a positive wavelength dispersion characteristic, Re1(550), Re2(550), 81, and 82 more preferably satisfy any one of the following (E) to (G).

(E) Re1(550) is from 105 nm to 115 nm, Re2(550) is from 210 nm to 250 nm, θ1 is from 19° to 35°, and θ2 is from 77° to 85°.
(F) Re1(550) is from 116 nm to 135 nm, Re2(550) is from 220 nm to 260 nm, θ1 is from 19° to 31°, and θ2 is from 77° to 83°.
(G) Re1(550) is from 136 nm to 145 nm, Re2(550) is from 220 nm to 260 nm, θ1 is from 19° to 27°, and θ2 is from 77° to 81°.

When the first retardation layer 1 shows a flat wavelength dispersion characteristic, and the second retardation layer 2 shows a positive wavelength dispersion characteristic, Re1(550), Re2(550), 81, and 82 most preferably satisfy any one of the following (H) to (K).

(H) Re1(550) is from 105 nm to 115 nm, Re2(550) is from 220 nm to 230 nm, θ1 is from 23° to 27°, and θ2 is from 79° to 81°.
(I) Re1(550) is from 116 nm to 125 nm, Re2(550) is from 220 nm to 250 nm, θ1 is from 19° to 27°, and θ2 is from 77° to 81°.
(J) Re1(550) is from 126 nm to 135 nm, Re2(550) is from 230 nm to 250 nm, θ1 is from 19° to 27°, and θ2 is from 77° to 81°.
(K) Re1(550) is from 136 nm to 145 nm, Re2(550) is from 245 nm to 255 nm, θ1 is from 19° to 23°, and θ2 is from 77° to 79°.

The thickness of the second retardation layer may be set so that a desired in-plane retardation may be obtained. Specifically, the thickness is preferably from 1 μm to 80 μm. When the second retardation layer includes an alignment fixed layer of a liquid crystal compound, the thickness is more preferably from 1 μm to 10 μm, still more preferably from 1 μm to 6 μm.

In one embodiment, the refractive index ellipsoid of the second retardation layer satisfies a relationship of nx=nz>ny, and the Nz coefficient of the second retardation layer is, for example, more than −0.1 and less than 0.1. In another embodiment, the refractive index ellipsoid of the second retardation layer satisfies a relationship of nx>ny=nz, and the Nz coefficient of the second retardation layer is, for example, more than 0.9 and less than 1.1.

C-1-1. Second Retardation Layer Whose Refractive Index Ellipsoid satisfies Relationship of nx>ny=nz

The second retardation layer whose refractive index ellipsoid satisfies a relationship of nx>ny=nz may include any appropriate material that may satisfy such optical characteristics and mechanical characteristics as described above. In one embodiment, the second retardation layer may include an alignment fixed layer of a liquid crystal compound. The use of the liquid crystal compound can make a difference between the nx and ny of the retardation layer to be obtained much larger than that in the case where a non-liquid crystal material is used, and hence can significantly reduce the thickness of the retardation layer for obtaining a desired in-plane retardation. As a result, a further thinning of the optical laminate (finally, an image display apparatus) can be achieved. The term “alignment fixed layer” as used herein refers to a layer in which the liquid crystal compound is aligned in a predetermined direction and its alignment state is fixed. In this embodiment, a rod-shaped liquid crystal compound is typically aligned in a state of being aligned in the slow axis direction of the second retardation layer (homogeneous alignment). An example of the liquid crystal compound is a liquid crystal compound whose liquid crystal phase is a nematic phase (nematic liquid crystal). As such liquid crystal compound, for example, a liquid crystal polymer or a liquid crystal monomer may be used. The expression mechanism of the liquid crystallinity of the liquid crystal compound may be lyotropic or thermotropic. The liquid crystal polymer and the liquid crystal monomer may be used alone or in combination thereof.

When the liquid crystal compound is the liquid crystal monomer, the liquid crystal monomer is preferably a polymerizable monomer or a cross-linkable monomer. This is because the alignment state of the liquid crystal monomer can be fixed by polymerizing or cross-linking the liquid crystal monomer. After the alignment of the liquid crystal monomer, for example, when molecules of the liquid crystal monomer are polymerized or cross-linked with each other, the alignment state can be fixed as a result. In this case, a polymer is formed through the polymerization and a three-dimensional network structure is formed through the cross-linking, and the polymer and the structure are non-liquid crystalline. Therefore, the formed second retardation layer does not undergo, for example, a transition caused by a temperature change to a liquid crystal phase, a glass phase, or a crystal phase, which is peculiar to a liquid crystalline compound. As a result, the second retardation layer becomes a retardation layer that is extremely excellent in stability without being affected by a temperature change.

The temperature range in which the liquid crystal monomer shows liquid crystallinity varies depending on its kind. Specifically, the temperature range is preferably from 40° C. to 120° C., more preferably from 50° C. to 100° C., most preferably from 60° C. to 90° C.

Any appropriate liquid crystal monomer may be adopted as the liquid crystal monomer. For example, a polymerizable mesogenic compound and the like described in JP 2002-533742 A (WO 00/37585 A1), EP 358208 B1 (U.S. Pat. No. 5,211,877 B), EP 66137 B1 (U.S. Pat. No. 4,388,453 B), WO 93/22397 A1, EP 0261712 A1, DE 19504224 A1, DE 4408171 A1, GB 2280445 B, and the like may be used. Specific examples of such polymerizable mesogenic compound include a product available under the product name LC242 from BASF SE, a product available under the product name E7 from Merck KGaA, and a product available under the product name LC-Sillicon-CC3767 from Wacker Chemie AG. The liquid crystal monomer is preferably, for example, a nematic liquid crystal monomer.

The alignment fixed layer of a liquid crystal compound may be formed by: subjecting the surface of a predetermined substrate to alignment treatment; applying an application liquid containing a liquid crystal compound onto the surface; aligning the liquid crystal compound in a direction corresponding to the alignment treatment; and fixing the alignment state. In one embodiment, the substrate is any appropriate resin film, and the alignment fixed layer formed on the substrate may be transferred onto the surface of the first retardation layer.

As the alignment treatment, any appropriate alignment treatment may be adopted. Specific examples thereof include mechanical alignment treatment, physical alignment treatment, and chemical alignment treatment. Specific examples of the mechanical alignment treatment include rubbing treatment and stretching treatment. Specific examples of the physical alignment treatment include magnetic field alignment treatment and electric field alignment treatment. Specific examples of the chemical alignment treatment include an oblique deposition method and photoalignment treatment. Any appropriate conditions may be adopted as treatment conditions for the various alignment treatments in accordance with purposes.

The alignment of the liquid crystal compound is performed through treatment at a temperature at which the liquid crystal compound shows a liquid crystal phase depending on the kind of the liquid crystal compound. When the treatment at such temperature is performed, the liquid crystal compound adopts a liquid crystal state, and the liquid crystal compound is aligned depending on the alignment treatment direction of the surface of the substrate.

In one embodiment, the fixation of the alignment state is performed by cooling the liquid crystal compound aligned as described above. When the liquid crystal compound is the polymerizable monomer or the cross-linkable monomer, the fixation of the alignment state is performed by subjecting the liquid crystal compound aligned as described above to polymerization treatment or cross-linking treatment.

Specific examples of the liquid crystal compound and details about the method of forming the alignment fixed layer are described in JP 2006-163343 A. The description of the laid-open publication is incorporated herein by reference.

C-1-2. Second Retardation Layer Whose Refractive Index Ellipsoid Satisfies Relationship of Nx=Nz>Ny

The second retardation layer whose refractive index ellipsoid satisfies a relationship of nx=nz>ny may include any appropriate material that may satisfy such optical characteristics and mechanical characteristics as described above.

In one embodiment, the second retardation layer may include an alignment fixed layer of a liquid crystalline composition containing a discotic liquid crystal compound aligned in a substantially vertical manner. The term “discotic liquid crystal compound” as used herein refers to a compound having a disc-shaped mesogen group in its molecular structure and having 2 to 8 side chains radially bonded to the mesogen group via an ether bond or an ester bond. The mesogen group is, for example, a group having a structure illustrated in FIG. 1 on P. 22 of “Liquid Crystal Dictionary” (Baifukan Co., Ltd.). Specific examples thereof include benzene, triphenylene, truxene, pyran, rufigallol, porphyrin, andametal complex. Thediscotic liquid crystal compound aligned in a substantially vertical manner ideally has an optical axis in one direction in a film plane. The term “discotic liquid crystal compound aligned in a substantially vertical manner” refers to a discotic liquid crystal compound in a state in which its disc surface is vertical to a film plane and its optical axis is parallel to the film plane.

The liquid crystalline composition containing the discotic liquid crystal compound is not particularly limited as long as the composition contains the discotic liquid crystal compound to show liquid crystallinity. The content of the discotic liquid crystal compound in the liquid crystalline composition is preferably 40 parts by weight or more and less than 100 parts by weight, more preferably 50 parts by weight or more and less than 100 parts by weight, most preferably 70 parts by weight or more and less than 100 parts by weight with respect to 100 parts by weight of the total solid content of the liquid crystalline composition.

A retardation film formed of the alignment fixed layer of the liquid crystalline composition containing the discotic liquid crystal compound aligned in a substantially vertical manner may be obtained by a method described in JP 2001-56411 A. When the liquid crystalline composition containing the discotic liquid crystal compound is applied in one direction, a direction in which a refractive index in the film plane increases (slow axis direction) is generated in a direction substantially perpendicular to the application direction, thereby to produce the retardation film formed of the alignment fixed layer of the liquid crystalline composition containing the discotic liquid crystal compound aligned in a substantially vertical manner. Accordingly, a roll-shaped retardation film (negative A-plate) having a slow axis in a direction perpendicular to its lengthwise direction can be produced by continuous application without particular performance of any subsequent stretching or shrinking treatment. Roll-to-roll operation can be performed in the lamination of the roll-shaped retardation film having the slow axis in the direction perpendicular to its lengthwise direction with any other layer.

In another embodiment, the second retardation layer may include an alignment fixed layer of a liquid crystalline composition containing a lyotropic liquid crystal compound subjected to homogeneous alignment. The term “lyotropic liquid crystal compound” as used herein refers to a liquid crystal compound that expresses a liquid crystal phase under a solution state depending on the concentration of a solute. Any appropriate compound may be used as the lyotropic liquid crystal compound. Specific examples of the lyotropic liquid crystal compound include: an amphipathic compound having a hydrophilic group and a hydrophobic group at both terminals of a molecule thereof; a chromonic compound having an aromatic ring having imparted thereto water solubility; and polymer compounds whose main chains each have a rod-shaped skeleton, such as a cellulose derivative, polypeptide, and a nucleic acid. Of those, an alignment fixed layer of a liquid crystalline composition containing a lyotropic liquid crystal compound subjected to homogeneous alignment in which the lyotropic liquid crystal compound is a chromonic compound having an aromatic ring having imparted thereto water solubility is preferred as the retardation film to be used in the second retardation layer.

The liquid crystalline composition containing the lyotropic liquid crystal compound is not particularly limited as long as the composition contains the lyotropic liquid crystal compound to show liquid crystallinity. The content of the lyotropic liquid crystal compound in the liquid crystalline composition is preferably 40 parts by weight or more and less than 100 parts by weight, more preferably 50 parts by weight or more and less than 100 parts by weight, most preferably 70 parts by weight or more and less than 100 parts by weight with respect to 100 parts by weight of the total solid content of the liquid crystalline composition.

A retardation film formed of the alignment fixed layer of the liquid crystalline composition containing the lyotropic liquid crystal compound subjected to homogeneous alignment may be obtained by a method described in JP 2002-296415 A. When the liquid crystalline composition containing the lyotropic liquid crystal compound is applied in one direction, a direction in which a refractive index in the film plane increases (slow axis direction) is generated in a direction substantially perpendicular to the application direction, thereby to produce the retardation film formed of the alignment fixed layer of the liquid crystalline composition containing the lyotropic liquid crystal compound subjected to homogeneous alignment. Accordingly, a roll-shaped retardation film having a slow axis in a direction perpendicular to its lengthwise direction can be produced by continuous application without particular performance of any subsequent stretching or shrinking treatment. Roll-to-roll operation can be performed in the lamination of the roll-shaped retardation film having the slow axis in the direction perpendicular to its lengthwise direction with any other layer.

C-2. Second Retardation Layer Showing Flat Wavelength Dispersion Characteristic

As described above, the second retardation layer may be a retardation layer showing such a flat wavelength dispersion characteristic that its in-plane retardation value remains substantially unchanged irrespective of the wavelength of measurement light.

The thickness of the second retardation layer may be set so that a desired in-plane retardation may be obtained. Specifically, the thickness is preferably from 1 μm to 160 μm, more preferably from 10 μm to 80 μm, most preferably from 20 μm to 50 μm.

In one embodiment, the refractive index ellipsoid of the second retardation layer satisfies a relationship of nx>ny=nz, and the Nz coefficient of the first retardation layer is, for example, more than 0.9 and less than 1.1. In another embodiment, the refractive index ellipsoid of the first retardation layer satisfies a relationship of nx=nz>ny, and the Nz coefficient of the first retardation layer is, for example, more than −0.1 and less than 0.1.

The second retardation layer whose refractive index ellipsoid satisfies a relationship of nx>ny=nz may include any appropriate material that may satisfy such optical characteristics and mechanical characteristics as described above, and may include, for example, a material described in the section B-1. The second retardation layer whose refractive index ellipsoid satisfies a relationship of nx=nz>ny may include any appropriate material that may satisfy such optical characteristics and mechanical characteristics as described above, and may include, for example, a material described in the section B-2.

D. Polarizer

Any appropriate polarizer may be adopted as the polarizer. For example, a resin film forming the polarizer may be a single-layer resin film, or may be a laminate of two or more layers.

Specific examples of the polarizer including a single-layer resin film include: a polarizer obtained by subjecting a hydrophilic polymer film, such as a polyvinyl alcohol (PVA)-based film, a partially formalized PVA-based film, or an ethylene-vinyl acetate copolymer-based partially saponified film, to dyeing treatment with a dichroic substance, such as iodine or a dichroic dye, and stretching treatment; and a polyene-based alignment film, such as a dehydration-treated product of PVA or a dehydrochlorination-treated product of polyvinyl chloride. A polarizer obtained by dyeing the PVA-based film with iodine and uniaxially stretching the resultant is preferably used because the polarizer is excellent in optical characteristics.

The dyeing with iodine is performed by, for example, immersing the PVA-based film in an aqueous solution of iodine. The stretching ratio of the uniaxial stretching is preferably from 3 times to 7 times. The stretching may be performed after the dyeing treatment, or may be performed while the dyeing is performed. In addition, the dyeing may be performed after the stretching has been performed. The PVA-based film is subjected to swelling treatment, cross-linking treatment, washing treatment, drying treatment, or the like as required. For example, when the PVA-based film is immersed in water to be washed with water before the dyeing, contamination or an antiblocking agent on the surface of the PVA-based film can be washed off. In addition, the PVA-based film is swollen and hence dyeing unevenness or the like can be prevented.

The polarizer obtained by using the laminate is specifically, for example, a polarizer obtained by using a laminate of a resin substrate and a PVA-based resin layer (PVA-based resin film) laminated on the resin substrate, or a laminate of a resin substrate and a PVA-based resin layer formed on the resin substrate through application. The polarizer obtained by using the laminate of the resin substrate and the PVA-based resin layer formed on the resin substrate through application may be produced by, for example, a method involving: applying a PVA-based resin solution onto the resin substrate; drying the solution to form the PVA-based resin layer on the resin substrate, to thereby provide the laminate of the resin substrate and the PVA-based resin layer; and stretching and dyeing the laminate to turn the PVA-based resin layer into the polarizer. In this embodiment, the stretching typically includes the stretching of the laminate under a state in which the laminate is immersed in an aqueous solution of boric acid. The stretching may further include the aerial stretching of the laminate at high temperature (e.g., 95° C. or more) before the stretching in the aqueous solution of boric acid as required. The resultant laminate of the resin substrate and the polarizer may be used as it is (i.e., the resin substrate may be used as a protective layer for the polarizer). Alternatively, a product obtained as described below may be used: the resin substrate is peeled from the laminate of the resin substrate and the polarizer, and any appropriate protective layer in accordance with purposes is laminated on the peeling surface. Details about such method of producing a polarizer are described in, for example, JP 2012-73580 A. The entire description of the laid-open publication is incorporated herein by reference.

The thickness of the polarizer is preferably 25 μm or less, more preferably from 1 μm to 12 μm, still more preferably from 3 μm to 8 μm. When the thickness of the polarizer falls within such range, curling at the time of heating can be satisfactorily suppressed, and satisfactory appearance durability at the time of heating is obtained.

The polarizer preferably shows absorption dichroism at any wavelength in the wavelength range of from 380 nm to 780 nm. The single layer transmittance of the polarizer is from 42.0% to 46.0%, preferably from 44.5% to 46.0%. The polarization degree of the polarizer is preferably 97.0% or more, more preferably 99.0% or more, still more preferably 99.9% or more.

E. Third Retardation Layer

The thickness of the third retardation layer is preferably from 0.1 μm to 50 μm, more preferably from 10 μm to 30 μm. The third retardation layer preferably also functions as a protective layer for the polarizer. In this case, a separate protective layer may not be arranged between the polarizer and the third retardation layer. In this case, the third retardation layer is bonded to the polarizer via any appropriate adhesion layer.

In one embodiment, the refractive index ellipsoid of the third retardation layer satisfies a relationship of nx>nz>ny, and the Nz coefficient of the third retardation layer is, for example, from 0.1 to 0.9.

In another embodiment, the refractive index ellipsoid of the third retardation layer satisfies a relationship of nx>ny>nz, and the Nz coefficient of the third retardation layer is, for example, 1.03 or more. In this case, the optical laminate includes the fourth retardation layer whose refractive index ellipsoid satisfies a relationship of nz>nx>ny.

E-1. Third Retardation Layer Whose Refractive Index Ellipsoid Satisfies Relationship of Nx>Nz>Ny

The in-plane retardation Re3(550) of the third retardation layer whose refractive index ellipsoid satisfies a relationship of nx>nz>ny is preferably from 150 nm to 400 nm, more preferably from 180 nm to 350 nm. An angle θ3 formed by the absorption axis of the polarizer and the slow axis of the third retardation layer is preferably from 87° to 93° or from −3° to 3°, more preferably from 89° to 91° or from −1° to 1°. The third retardation layer may include any appropriate material that may satisfy such optical characteristics and mechanical characteristics as described above. In one embodiment, the retardation layer may include any appropriate retardation film. The retardation film preferably contains at least one kind of thermoplastic resin selected from a norbornene-based resin, a cellulose-based resin, a carbonate-based resin, and an ester-based resin. The retardation film more preferably contains at least one kind of thermoplastic resin selected from a norbornene-based resin and a carbonate-based resin. This is because any such resin is excellent in heat resistance, transparency, and formability. Any appropriate method may be adopted as a method of producing the retardation film. A typical example thereof is a method involving: forming a thermoplastic resin or a composition containing the thermoplastic resin into a sheet shape to provide a polymer film; bonding a shrinkable film to one surface, or each of both surfaces, of the polymer film; and stretching the resultant under heat. The heat stretching is, for example, heat stretching with a roll stretching machine according to a longitudinal uniaxial stretching method.

E-2. Third Retardation Layer Whose Refractive Index Ellipsoid Satisfies Relationship of Nx>Ny>Nz

The in-plane retardation Re3(550) of the third retardation layer whose refractive index ellipsoid satisfies a relationship of nx>ny>nz is preferably from 90 nm to 160 nm, more preferably from 110 nm to 155 nm. The angle θ3 formed by the absorption axis of the polarizer and the slow axis of the third retardation layer is preferably from 87° to 93°, more preferably from 89° to 91°. The third retardation layer may include any appropriate material that may satisfy such optical characteristics and mechanical characteristics as described above.

In one embodiment, the third retardation layer may include any appropriate retardation film. A resin forming the retardation film is preferably a norbornene-based resin or a polycarbonate-based resin. Any appropriate method including the step of stretching a resin film may be adopted as a method of producing the retardation film. A stretching method is, for example, lateral uniaxial stretching (fixed-end biaxial stretching) or sequential biaxial stretching. A stretching temperature is preferably from 135° C. to 165° C., more preferably from 140° C. to 160° C. A stretching ratio is preferably from 2.8 times to 3.2 times, more preferably from 2.9 times to 3.1 times.

In another embodiment, the third retardation layer may include any appropriate non-liquid crystalline material. In this case, typically, the thickness of the third retardation layer is preferably from 0.1 μm to 10 μm, more preferably from 0.1 μm to 8 μm, particularly preferably from 0.1 μm to 5 μm. The non-liquid crystalline material is preferably a non-liquid crystalline polymer, and preferred specific examples thereof include polymers, such as polyamide, polyimide, polyester, polyether ketone, polyamide imide, and polyester imide. Those polymers may be used alone or as a mixture thereof. The third retardation layer may be typically formed by applying a solution of the non-liquid crystalline polymer to a substrate film and removing its solvent. In a method of forming the third retardation layer, treatment for imparting optical biaxiality (nx>ny>nz) (e.g., stretching treatment) is preferably performed. The performance of such treatment can reliably impart a difference in refractive index (nx>ny) into the plane of the retardation layer. A specific example of the polyimide and a specific example of the method of forming the third retardation layer are a polymer and a production method described in JP 2006-234848 A, respectively.

F. Fourth Retardation Layer

As described above, the refractive index characteristic of the fourth retardation layer satisfies a relationship of nz>nx>ny. The in-plane retardation Re4 (550) of the fourth retardation layer is preferably from 10 nm to 150 nm, more preferably from 10 nm to 80 nm. The Nz coefficient of the fourth retardation layer is, for example, −0.1 or less, preferably −2.0 or less. An angle formed by the absorption axis of the polarizer and the slow axis of the fourth retardation layer is preferably from 87° to 93°, more preferably from 89° to 91°.

The fourth retardation layer may include any appropriate material that may satisfy such optical characteristics and mechanical characteristics as described above. In one embodiment, the fourth retardation layer may include a liquid crystal layer fixed to homeotropic alignment. A liquid crystal material (liquid crystal compound) that can be subjected to homeotropic alignment may be a liquid crystal monomer or may be a liquid crystal polymer. Specific examples of the liquid crystal compound and a method of forming the liquid crystal layer are a liquid crystal compound and a formation method described in [0020] to [0042] of JP 2002-333642 A, respectively. In this case, the thickness of the retardation layer is preferably from 0.1 μm to 6 μm, more preferably from 0.2 μm to 3 μm. In another embodiment, the fourth retardation layer may be a retardation film formed of a fumaric acid diester-based resin described in JP 2012-32784 A. In this case, its thickness is preferably from 5 μm to 50 μm, more preferably from 5 μm to 35 μm.

G. Production Method

A method of producing the optical laminate typically includes the step of continuously bonding each of a first film of an elongate shape forming the first retardation layer 1, a second film of an elongate shape forming the second retardation layer 2, the polarizer 3 of an elongate shape, and a third film of an elongate shape forming the third retardation layer 4 to an adjacent film while conveying the films and the polarizer. In one embodiment, the second film is formed on a substrate, and the method further includes the step of bonding the second film formed on the substrate to the first film, followed by the peeling of the substrate. In another embodiment, the polarizer is formed on a substrate, and the method further includes the step of bonding the polarizer formed on the substrate to the second film, followed by the peeling of the substrate. In still another embodiment, the third film is formed on a substrate, and the method further includes the step of bonding the third film formed on the substrate to the polarizer, followed by the peeling of the substrate. Two or more of the embodiments may be combined.

H. Image Display Apparatus

The optical laminate described in the section A to the section F may be applied to an image display apparatus, such as a liquid crystal display apparatus. Therefore, the present invention encompasses an image display apparatus using the optical laminate. An image display apparatus according to the embodiment of the present invention includes the optical laminate described in the section A to the section F, and the optical laminate is arranged so that the first retardation layer, the second retardation layer, the polarizer, and the third retardation layer may be arranged from the viewer side of the image display apparatus in the stated order.

### EXAMPLES

Now, the present invention is specifically described by way of Examples. However, the present invention is not limited by these Examples. Measurement methods for characteristics are as described below.

### (1) Thickness

Measurement was performed with a digital micrometer (KC-351C manufactured by Anritsu Corporation).

### (2) Retardation Value

The refractive indices nx, ny, and nz of a retardation layer used in each of Example and Comparative Examples were measured with an automatic birefringence measuring apparatus (manufactured by Oji Scientific Instruments Co., Ltd., Automatic Birefringence Analyzer KOBRA-WPR). The measurement wavelengths for an in-plane retardation Re were 450 nm, 550 nm, and 650 nm, the measurement wavelength for a thickness direction retardation Rth was 550 nm, and the measurement temperature was 23° C.

(3) Hue Change and Transmittance Change in Accordance with Angle of Polarized Sunglasses

A light source (manufactured by Iwasaki Electric Co., Ltd., product name: “JCR 12V 50W 20H”) was arranged on the back surface side (third retardation layer side) of an optical laminate, and a polarizer simulating polarized sunglasses was arranged on the front surface side (surface protective film side) of the optical laminate. While the polarizer was rotated in the range of from 90° to −90°, light that had been output from the light source, and had passed the optical laminate and the polarizer was subjected to spectrum measurement with an integrating sphere-type spectral transmittance-measuring unit DOT-3C (manufactured by Murakami Color Research Laboratory). The hues “a” and “b” of the Hunter Lab color system were calculated from the resultant spectrum of the transmitted light, and were plotted on coordinates in which the “a” was indicated by an axis of abscissa and the “b” was indicated by an axis of ordinate. In addition, a transmittance (Y value), which was indicated by an axis of ordinate, was plotted against the angle of the polarizer simulating the polarized sunglasses, which was indicated by an axis of abscissa.

### Example 1

### 1. Production of Retardation Film a Forming First Retardation Layer

A biaxially stretched polypropylene film (manufactured by Toray Industries, Inc., product name: “TORAYFAN-HIGH SHRINKAGE-TYPE”, thickness: 60 μm) was bonded to each of both sides of a film of a cycloolefin-based resin obtained by hydrogenating a ring-opened polymer of a norbornene-based monomer (manufactured by Zeon Corporation, product name: “ZEONOR ZF14”, thickness: 40 μm) via an acrylic pressure-sensitive adhesive layer (thickness: 15 μm). After that, the resultant film was held in its lengthwise direction with a roll stretching machine, and was stretched in an air circulation-type drying oven at 148° C.±1° C. at a ratio of 1.40 times. The stretched film thus obtained was defined as a retardation film A. The retardation film A had a thickness of 35 μm, an in-plane retardation Re(550) of 110 nm, a ratio “Re(450)/Re(550)” of 1.00, and a ratio “Re(650)/Re(550)” of 1.00. In addition, the refractive index ellipsoid of the film satisfied a relationship of nx=nz>ny, and an angle formed by the slow axis and elongate direction thereof was 25°.

### 2. Production of Alignment Fixed Layer B of Liquid Crystal Compound Forming Second Retardation Layer

An optical alignment film was applied to the surface of a 100-micrometer thick elongate polyethylene terephthalate substrate (PET substrate) to subject the surface to optical alignment treatment in a direction at 10° with respect to its elongate direction. Meanwhile, 10 parts by weight of a polymerizable liquid crystal monomer showing a nematic liquid crystal phase (manufactured by BASF SE: product name: Paliocolor LC242) and 3 parts by weight of aphotopolymerizationinitiator for thepolymerizable liquidcrystal monomer (manufactured by BASF SE: product name: IRGACURE 907) were dissolved in 40 parts by weight of toluene to prepare a liquid crystal application liquid. The application liquid was applied to the surface of the PET substrate subjected to the optical alignment treatment with a bar coater, and was then dried by heating at 80° C. for 4 minutes to align its liquid crystal. The liquid crystal layer was cured by irradiating the liquid crystal layer with UV light. Thus, a laminate of an elongate shape in which an alignment fixed layer B was formed on the PET substrate (aligned fixed layer laminate) was obtained. The alignment fixed layer B had a thickness of 2 μm, an in-plane retardation Re (550) of 220 nm, a ratio “Re (450)/Re (550)” of 1.08, and a ratio “Re(650)/Re(550)” of 0.96. In addition, the refractive index ellipsoid of the layer satisfied a relationship of nx>ny=nz, and an angle formed by the slow axis and elongate direction thereof was 80°.

### 3. Production of Polarizer

An amorphous polyethylene terephthalate (A-PET) film of an elongate shape (manufactured by Mitsubishi Plastics, Inc., product name: “NOVACLEAR”, thickness: 100 μm) was prepared as a substrate, and an aqueous solution of a polyvinyl alcohol (PVA) resin (manufactured by The Nippon Synthetic Chemical Industry Co., Ltd., product name: “GOHSENOL (trademark) NH-26”) was applied to one surface of the substrate and dried at 60° C. to form a PVA-based resin layer having a thickness of 7 μm. The laminate thus obtained was immersed in an insolubilizing bath having a liquid temperature of 30° C. for 30 seconds (insolubilizing step). Next, the laminate was immersed in a dyeing bath having a liquid temperature of 30° C. for 60 seconds (dyeing step). Next, the laminate was immersed in a cross-linking bath having a liquid temperature of 30° C. for 30 seconds (cross-linking step). After that, the laminate was uniaxially stretched in its longitudinal direction (elongate direction) between rolls having different peripheral speeds while being immersed in an aqueous solution of boric acid having a liquid temperature of 60° C. The time period for which the laminate was immersed in the aqueous solution of boric acid was 120 seconds, and the laminate was stretched until immediately before its rupture. After that, the laminate was immersed in a washing bath, and was then dried with warm air at 60° C. (washing-drying step). Thus, a laminate of an elongate shape in which a polarizer having a thickness of 5 μm was formed on the substrate (polarizer laminate) was obtained.

### 4. Production of Retardation Film C Forming Third Retardation Layer

A shrinkable film having a thickness of 60 μm (manufactured by Toray Industries, Inc., product name: “TORAYFAN BO02873”) was bonded to one side of a 100-micrometer thick elongate polymer film containing a norbornene-based resin (manufactured by Optes Inc., product name: “ZEONOR ZF-14-100”) via an acrylic pressure-sensitive adhesive layer (thickness: 15 μm). After that, the resultant was stretched in an air circulation-type oven at 146° C. at a ratio of 1.38 times to provide a laminate of an elongate shape in which a retardation film C of an elongate shape was formed on the shrinkable film (retardation film laminate). The retardation film C had a thickness of 17 μm, an in-plane retardation Re(550) of 275 nm, a ratio “Re(450)/Re(550)” of 1.10, and a ratio “Re(650)/Re(550)” of 0.95. In addition, the refractive index ellipsoid of the film satisfied a relationship of nx>nz>ny, and an angle formed by the slow axis and elongate direction thereof was 90°.

### 5. Production of Optical Laminate

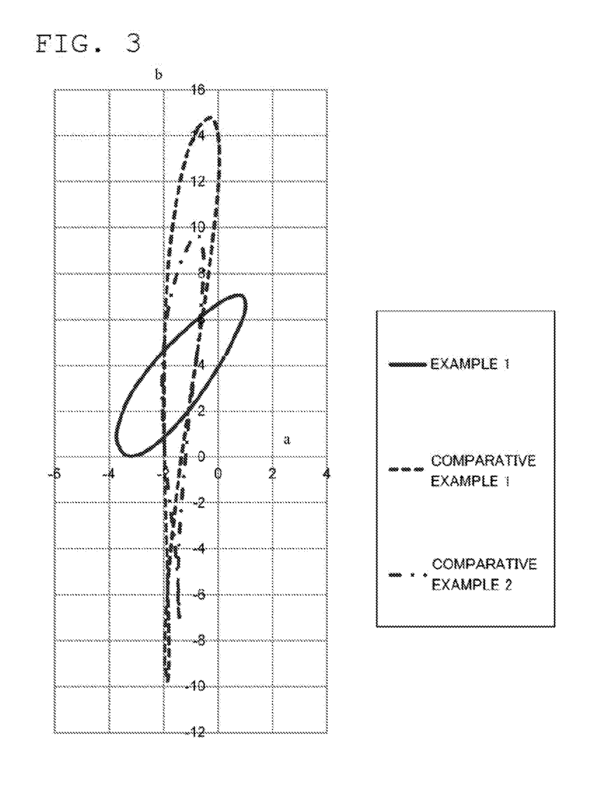

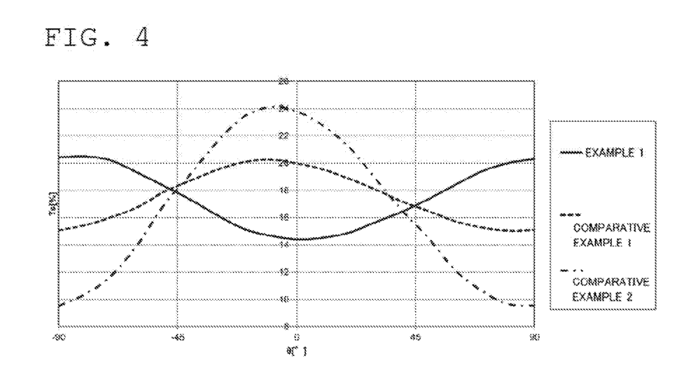

A surface protective film was bonded to one surface of the retardation film A. Next, the surface of the alignment fixed layer B of the alignment fixed layer laminate was bonded to the other surface of the retardation film A by a roll-to-roll process with their elongate directions aligned with each other. Next, the PET substrate was peeled from the alignment fixed layer laminate, and the surface of the polarizer of the polarizer laminate was bonded to the surface of the aligned fixed layer B by a roll-to-roll process with their elongate directions aligned with each other. Next, the substrate was peeled from the polarizer laminate, and the retardation film laminate was bonded to the surface of the polarizer by a roll-to-roll process with their elongate directions aligned with each other. Next, the shrinkable film was peeled from the retardation film laminate. Thus, an optical laminate in which the surface protective film, a first retardation layer, a second retardation layer, the polarizer, and a third retardation layer were laminated in the stated order was obtained. An acrylic pressure-sensitive adhesive was used in the bonding of the respective components. The optical laminate has an angle formed by the absorption axis of the polarizer and the slow axis of the first retardation layer of 25°, and an angle formed by the absorption axis of the polarizer and the slow axis of the second retardation layer of 80°. The resultant optical laminate was subjected to evaluations for a hue change and a transmittance change in accordance with the angle of polarized sunglasses. The result of the evaluation for a hue change is shown in FIG. 3, and the result of the evaluation for a transmittance change is shown in FIG. 4.

### Comparative Example 1

### 1. Production of Retardation Film D Forming First Retardation Layer

A film of an elongate shape formed from a polycarbonate resin pellet was obliquely stretched to provide a retardation film D of an elongate shape. The retardation film D had a thickness of 67 μm, an in-plane retardation Re(550) of 125 nm, a ratio “Re(450)/Re(550)” of 1.06, and a ratio “Re(650)/Re(550)” of 0.97. In addition, the refractive index ellipsoid of the film satisfied a relationship of nx>ny=nz, and an angle formed by the slow axis and elongate direction thereof was 45°.

### 2. Production of Optical Laminate

An optical laminate was produced in the same manner as in Example 1 except that the surface of the polarizer of the polarizer laminate was bonded to the retardation film D instead of the laminate of the retardation film A and the alignment fixed layer by a roll-to-roll process. The optical laminate is an optical laminate in which a first retardation layer, the polarizer, and a second retardation layer are laminated in the stated order, and has an angle formed by the absorption axis of the polarizer and the slow axis of the first retardation layer of 45°. The resultant optical laminate was subjected to evaluations for a hue change and a transmittance change in the same manner as in Example 1. The results are shown in FIG. 3 and FIG. 4.

### Comparative Example 2

An optical laminate was produced in the same manner as in Example 1 except that: the resultant retardation film A had an in-plane retardation Re(550) of 100 nm; an angle formed by the slow axis and elongate direction of the film was 45°; and the surface of the polarizer of the polarizer laminate was bonded to the above-mentioned retardation film A instead of the laminate of the retardation film A and the alignment fixed layer by a roll-to-roll process. The optical laminate is an optical laminate in which a first retardation layer, the polarizer, and a second retardation layer are laminated in the stated order, and has an angle formed by the absorption axis of the polarizer and the slow axis of the first retardation layer of 45°. The resultant optical laminate was subjected to evaluations for a hue change and a transmittance change in the same manner as in Example 1. The results are shown in FIG. 3 and FIG. 4.

<Evaluation>

As is apparent from FIG. 3, the area of the inside of a curve drawn by hue plots obtained in spectrum measurement through the optical laminate of Example 1 is smaller than those of curves drawn by hue plots obtained in spectrum measurement through the optical laminates of Comparative Example 1 and Comparative Example 2, or the change width of the former curve along an axis of ordinate is smaller than those of the latter curves. The foregoing means that light passing the optical laminate of Example 1 shows a hue change in accordance with the angle of the polarized sunglasses smaller than that shown by light passing any one of the optical laminates of Comparative Example 1 and Comparative Example 2. The amplitude of a curve obtained in transmittance measurement through the optical laminate of Example 1 is smaller than the amplitude of a curve obtained in transmittance measurement through the optical laminate of Comparative Example 2. The foregoing means that the optical laminate of Example 1 shows a transmittance change along with a change in angle of the polarizer simulating the polarized sunglasses smaller than that shown by the optical laminate of Comparative Example 2.

### INDUSTRIAL APPLICABILITY

The optical laminate of the present invention is suitably used in an image display apparatus (in particular, a liquid crystal display apparatus).

### REFERENCE SIGNS LIST

1 first retardation layer
2 second retardation layer
3 polarizer
4 third retardation layer
5 third retardation layer
6 fourth retardation layer
10 optical laminate
11 optical laminate

1. An optical laminate, comprising:
a first retardation layer;
a second retardation layer;
a polarizer; and
a third retardation layer,
the first retardation layer, the second retardation layer, the polarizer, and the third retardation layer being laminated from a viewer side in the stated order.

2. The optical laminate according to claim 1,
wherein in-plane retardations Re1 of the first retardation layer satisfy the following expressions:
Re1(450)/Re1(550)<1.03; and
Re1(650)/Re1(550)>0.97, and
wherein in-plane retardations Re2 of the second retardation layer satisfy the following expressions:
Re2(450)/Re2(550)≥1.03; and
Re2(650)/Re2(550)≤0.97
where Re1(450) and Re2(450) each represent an in-plane retardation measured at 23° C. with light having a wavelength of 450 nm, Re1(550) and Re2(550) each represent an in-plane retardation measured at 23° C. with light having a wavelength of 550 nm, and Re1(650) and Re2(650) each represent an in-plane retardation measured at 23° C. with light having a wavelength of 650 nm.

3. The optical laminate according to claim 2, wherein:
the in-plane retardation Re1(550) of the first retardation layer is from 105 nm to 115 nm, the in-plane retardation Re2(550) of the second retardation layer is from 190 nm to 260 nm, an angle θ1 formed by an absorption axis of the polarizer and a slow axis of the first retardation layer is from 19° to 35°, and an angle θ2 formed by the absorption axis of the polarizer and a slow axis of the second retardation layer is from 77° to 85°;
the in-plane retardation Re1(550) of the first retardation layer is from 116 am to 125 nm, the in-plane retardation Re2(550) of the second retardation layer is from 200 nm to 260 nm, the angle θ1 formed by the absorption axis of the polarizer and the slow axis of the first retardation layer is from 15° to 35°, and the angle θ2 formed by the absorption axis of the polarizer and the slow axis of the second retardation layer is from 75° to 850°;
the in-plane retardation Re1(550) of the first retardation layer is from 126 nm to 135 nm, the in-plane retardation Re2(550) of the second retardation layer is from 210 nm to 260 nm, the angle θ1 formed by the absorption axis of the polarizer and the slow axis of the first retardation layer is from 15° to 35°, and the angle θ2 formed by the absorption axis of the polarizer and the slow axis of the second retardation layer is from 75° to 85°; or
the in-plane retardation Re1(550) of the first retardation layer is from 136 um to 145 nm, the in-plane retardation Re2(550) of the second retardation layer is from 220 nm to 270 nm, the angle θ1 formed by the absorption axis of the polarizer and the slow axis of the first retardation layer is from 15° to 31°, and the angle θ2 formed by the absorption axis of the polarizer and the slow axis of the second retardation layer is from 75° to 83°.

4. The optical laminate according to claim 1, wherein the first retardation layer includes a stretched body of a polymer film, and the second retardation layer includes an alignment fixed layer of a liquid crystal compound.

5. The optical laminate according to claim 1,
wherein in-plane retardations Re1 of the first retardation layer satisfy the following expressions:
Re1(450)/Re1(550)<1.03; and
Re1(650)/Re1(550)>0.97, and
wherein in-plane retardations Re2 of the second retardation layer satisfy the following expressions:
Re2(450)/Re2(550)<1.03; and
Re2(650)/Re2(550)>0.97
where Re1(450) and Re2(450) each represent an in-plane retardation measured at 23° C. with light having a wavelength of 450 nm, Re1(550) and Re2(550) each represent an in-plane retardation measured at 23° C. with light having a wavelength of 550 um, and Re1(650) and Re2(650) each represent an in-plane retardation measured at 23° C. with light having a wavelength of 650 nm.

6. The optical laminate according to claim 1,
wherein a refractive index ellipsoid of the first retardation layer satisfies a relationship of nx=nz>ny, and
wherein a refractive index ellipsoid of the second retardation layer satisfies a relationship of nx>ny=nz.

7. The optical laminate according to claim 1,
wherein a refractive index ellipsoid of the first retardation layer satisfies a relationship of nx>ny=nz, and
wherein a refractive index ellipsoid of the second retardation layer satisfies a relationship of nx−nz>ny.

8. An image display apparatus, comprising the optical laminate of claim 1.

9. A method of producing an optical laminate of an elongate shape in which a first retardation layer, a second retardation layer, a polarizer, and a third retardation layer are laminated in the stated order,
the method comprising the step of continuously bonding each of a first film of an elongate shape forming the first retardation layer, a second film of an elongate shape forming the second retardation layer, the polarizer of an elongate shape, and a third film of an elongate shape forming the third retardation layer to an adjacent film while conveying the films and the polarizer.

10. An optical laminate, comprising:
a first retardation layer;
a second retardation layer;
a polarizer, and
a third retardation layer,
the first retardation layer, the second retardation layer, the polarizer, and the third retardation layer being laminated from a viewer side in the stated order,
wherein:
a refractive index ellipsoid of the first retardation layer satisfies a relationship of nx=nz>ny, and a refractive index ellipsoid of the second retardation layer satisfies a relationship of nx>ny=nz; or
a refractive index ellipsoid of the first retardation layer satisfies a relationship of nx>ny=nz, and a refractive index ellipsoid of the second retardation layer satisfies a relationship of nx−=nz>ny.

11. The optical laminate according to claim 10, wherein the first retardation layer includes a stretched body of a polymer film, and the second retardation layer includes an alignment fixed layer of a liquid crystal compound.
